(19) United States
(12) Patent Application Publication
(10) Pub. No.: US 2024/0219222 A1
(43) Pub. Date: Jul. 4, 2024

(54) SYSTEMS, DEVICES AND METHODS FOR WEIGHING

(71) Applicant: Gallagher Group Limited, Hamilton (NZ)

(72) Inventors: Mathew Bell, Hamilton (NZ); John Harrison, Hamilton (NZ); Nick Body, Hamilton (NZ); Ankur Tyagi, Hamilton (NZ); Ondrej Pohl, Hamilton (NZ); Paul Clifford Reid, Hamilton (NZ); Roy Huang, Hamilton (NZ); Thomas Carlton Andrews, Hamilton (NZ)

(73) Assignee: Gallagher Group Limited, Hamilton (NZ)

(21) Appl. No.: 18/288,984

(22) PCT Filed: Apr. 29, 2022
(86) PCT No.: PCT/NZ2022/050050

§ 371 Date: Oct. 30, 2023

(30) Foreign Application Priority Data
Apr. 30, 2021 (NZ) 775549

(51) Int. Cl. G01G 23/18; G01G 21/23

(52) U.S. Cl. CPC G01G 23/18; G01G 21/23

(57) ABSTRACT

A wireless loadbar weighing system is described, including a first loadbar and a second loadbar, where the first loadbar and the second loadbar are configured to support a weighing platform in use. Each of the first loadbar and the second loadbar are configured to measure force applied by the weighing platform, and produce first measured force data and second measured force data respectively. Each of the first loadbar and the second loadbar include a processing module including a wireless communication device. At least one of the first loadbar and the second loadbar is configured to wirelessly transmit, to a remote device for further processing and/or display, at least one of: the first measured force data and the second measured force data, and a weight measurement of a mass supported by the weighing platform determined based on the first measured force data and the second measured force data.

### STATEMENT OF CORRESPONDING APPLICATIONS

This application is based on the Provisional specification filed in relation to New Zealand Patent Application No. 775549, the entire contents of which are incorporated herein by reference.

### TECHNICAL FIELD

The present disclosure relates to systems, devices, and methods for weighing, more particularly utilising wireless technology for transmission of data.

### BACKGROUND

Measuring animal weight is an important requirement for efficient animal husbandry. For example, animal weight may be used to determine the correct amount of feed an animal should receive, how efficiently a particular animal can transform feed to weight gain (a common measure of animal performance), the value of an animal relative to market price, predicting growth by analysing weight in relation to feed intake, when the optimal time may be to send the animal to market, and it can be a key indicator for determining the status of an animal's health. Animal weight can also be used for measuring the correct dose of therapeutic pharmaceutical to treat animal diseases, to avoid the risk of underdosing or overdosing. Weighing can also help determining the weaning time of an animal.

Weigh scales used for animal weighing typically connect to loadbars which support a platform for weighing animals on. Historically the weigh scale device is connected to the loadbars by cables. The connecting cables are one of the main contributors to reliability problems with known weighing systems.

A problem with these cables is that they are easily damaged. In animal weighing situations the environment is typically very harsh for electronic systems. There is the risk of mechanical damage through the movement of heavy animals (e.g. over 1000 kg cows and cattle), with high forces produced by the weight of heavy animals concentrated on small footprints. Highly corrosive materials such as animal urine and dung may be present. Further, weighing is often performed in very wet environments where animal dung is washed down by high pressure hoses and water ponding may occur where the weighing operation is performed. As a result, such cabling can be a highly susceptible to causing failure of the weighing system through, ingress of water or damage to the cable. Only a small amount of damage to a cable or cable entry point can result in failure or inaccurate measurements.

Additionally, where the system loses accuracy it may not be known for some time until a calibration test is made, or until the accuracy becomes so bad that it becomes obvious that incorrect weighing measurements are being made. In some circumstances, for example where moisture has got into the strain gauge electronics of a load cell of a loadbar, the load cell will almost certainly need to be sent to a service centre for repair. Such damage may also prevent transmission of weighing signals and power between the loadbars and the weighscale. When the weighing system is out of action it is most inconvenient for the user, and may take some time and effort to get fixed as the loadbars may need to be removed from under the weighing platform and returned to a service centre for repair. The weighing platform and loadbars may weigh many tens of kilograms and so are not readily removed, or easily sent away, for repair.

Also where the weighing system was providing inaccurate results due to damage or ingress of water, a farmer may suffer loss, as the farmer is often paid according to weight of animals and sometimes the animals must be between a lower and an upper weight to achieve optimal revenue on the sale of animals.

Furthermore, when setting up a weighing platform and system much care needs to be taken on the routing of the cables to avoid damage. This may be inconvenient or difficult to achieve depending on the physical constraints of the weighing location.

Wireless loadbars for weighing systems offer the advantage of reduced wiring around the animal weighing area which results in fewer failures due to mechanical damage of wiring and potentially reduced setup time and cost. However, proposed solutions to date are susceptible to issues with regard to one or more of power consumption, interference with wireless signals in the typical environment in which loadbars are installed, and ease of access/disassembly for servicing.

It should be appreciated that while aspects of the present disclosure are envisaged as having particular application to weighing of animals, and in particular livestock, the disclosure may also be applied to other weighing arrangements where multiple load bars or load cells are located beneath a weighing platform and where reduction of interconnecting wires would yield an advantage.

Aspects of the technology of the present disclosure are directed to overcoming one or more of the problems discussed above. It is an object of the present invention to address one or more of the foregoing problems or at least to provide the public with a useful choice.

Further aspects and advantages of the present disclosure will become apparent from the ensuing description which is given by way of example only.

### SUMMARY

According to one aspect of the present technology there is provided a wireless loadbar weighing system including:
a first loadbar;
a second loadbar;
wherein the first loadbar and the second loadbar are configured to support a weighing platform in use,
wherein each of the first loadbar and the second loadbar are configured to measure force applied by the weighing platform, and produce first measured force data and second measured force data respectively,
wherein each of the first loadbar and the second loadbar include a processing module including a wireless communication device,
wherein at least one of the first loadbar and the second loadbar is configured to wirelessly transmit, to a remote device for further processing and/or display, at least one of: the first measured force data and the second measured force data, and a weight measurement of a mass supported by the weighing platform determined based on the first measured force data and the second measured force data.

In examples, the first loadbar is configured to wirelessly transmit the first measured force data to the second loadbar,
wherein the second loadbar is further configured to wirelessly transmit the first measured force data and the second measured force data to the remote device,
wherein the remote device is configured to determine a weight measurement of a mass supported by the weighing platform based on the first measured force data and the second measured force data.

In examples, the first loadbar is configured to wirelessly transmit the first measured force data to the remote device, and the second loadbar to wirelessly transmit the second measured force data to the remote device,
wherein the remote device is configured to determine a weight measurement of a mass supported by the weighing platform based on the first measured force data and the second measured force data.

In examples, the first loadbar is configured to wirelessly transmit the first measured force data to the second loadbar, and the second loadbar is configured to determine a weight measurement of a mass supported by the weighing platform based on the first measured force data and the second measured force data, and
wherein the second loadbar is further configured to wirelessly transmit the weight measurement to a remote device for further processing and/or display.

According to one aspect of the present technology there is provided a wireless loadbar weighing system including:
a first loadbar;
a second loadbar;
wherein the first loadbar and the second loadbar are configured to support a weighing platform in use,
wherein each of the first loadbar and the second loadbar are configured to measure force applied by the weighing platform, and produce first measured force data and second measured force data respectively,
wherein each of the first loadbar and the second loadbar include a processing module including a wireless communication device,
wherein the first loadbar is configured to wirelessly transmit the first measured force data to the second loadbar, and the second loadbar is configured to determine a weight measurement of a mass supported by the weighing platform based on the first measured force data and the second measured force data, and
wherein the second loadbar is further configured to wirelessly transmit the weight measurement to a remote device for further processing and/or display.

In examples, the first measured force data includes a plurality of force measurements, and the first measured force data is transmitted to the second loadbar as a force data packet.

In examples, each force data packet may include two to eight force measurements. In examples, each force data packet may include less than five force measurements. In examples force data packet may include two force measurements.

In examples the remote device may be one or more of: a weighscale device, a user device (e.g. a mobile phone, tablet computer, or laptop computer), and a relay device configured to transmit the indicator of to a remote database.

In examples the weighscale device may include a display device, and may be configured to display the weight measurement received. In examples the weighscale device may be configured to record the weight measurement.

In examples, a plurality of weight measurements may be transmitted to the remote device as a weight data packet.

In examples, each weight data packet may include three to six weight measurements. In examples, each weight data packet may include less than five weight measurements. In examples each weight data packet may include four weight measurements.

In examples, the weight measurement is transmitted from the second loadbar to the remote device at intervals of less than one second. In examples, the weight measurement transmission intervals are not more than 300 milliseconds. In examples, the weight measurement transmission intervals are not less than 100 milliseconds. In examples, the weight measurement transmission intervals are between 150 milliseconds to 250 milliseconds. In examples, the weight measurement transmission intervals are in the order of 200 milliseconds.

In examples, the force measurements are captured at intervals of not more than 30 milliseconds. In examples, the force measurement capture intervals are between 5 milliseconds to 20 milliseconds. In examples, the force measurement capture intervals are in the order of 12.5 milliseconds.

In examples, the first measured force data is transmitted from the first loadbar to the second loadbar at intervals of not more than 100 milliseconds. In examples, the force measurement transmission intervals are not more than 50 milliseconds. In examples, the force measurement transmission intervals are between 10 milliseconds to 30 milliseconds. In examples, the force measurement transmission intervals are in the order of 25 milliseconds.

In examples, transmission of the first measured force data and transmission of the weight measurement are non-coincident (i.e. are sent at intervals such that the respective transmissions do not coincide).

In examples, each force measurement of the first measured force data and the second measured force data may have an associated timestamp. It should be appreciated that means other than a timestamp may be used to provide a temporal order among the force measurements to enable matching of force measurements between the first measured force data and the second measured force data.

In examples, respective force measurements of the first measured force data and the second measured force data are aligned (for example, utilising the timestamps) before determining the weight measurement.

In examples, the received first measured force data is included in a first measured force data stream, and the second measured force data is included in a second measured force data stream.

In examples, force measurements may not be included in, or may be discarded from, a measured force data stream until force measurements have been received from both processing modules within a predetermined time interval.

In examples, alignment of the respective force measurements of the first measured force data stream and the second measured force data stream may include discarding of a force measurement from the first measured force data stream or the second measured force data stream.

In examples, a force measurement may be discarded based on a determined time distance between force measurements of the first measured force data and the second measured force data respectively.

In examples, each of the processing modules may include an analog to digital converter having an associated clock, wherein the clock rate between the respective processing modules is less than 1.5 hertz.

In examples, the clocks of the respective processing modules may be resynchronized periodically—for example at intervals of between 40 to 80 seconds.

In examples each wireless communication device is configured to utilize a low-power wireless protocol, for example the Bluetooth® Low Energy protocol.

In examples, one of the respective processing modules of a pair of loadbars (e.g. the first loadbar and the second loadbar) may be selectively configured as a primary processing module responsible for determining the weight measurement and transmission of same to the remote device.

In examples, configuration of a processing module as the primary processing module may be based on a relative battery state of charge between the loadbars.

In examples, configuration of a processing module as the primary processing module may be based on a relative signal strength of a wireless connection between the processing modules and a remote device.

In examples, the respective processing modules may be configured to have an affinity established therebetween, wherein the processing modules are configured to only transmit measured force data to another processing module with which it has affinity.

In examples, a user device may communicate with the respective processing modules in order to establish affinity.

In examples, when affinity is established between an existing processing module and a replacement processing module, the existing processing module is configured to transmit configuration data to the replacement processing module. In examples, the configuration data includes data relating to a type of loadbar to which the processing module is provided. For example, the type of loadbar may relate to a weight classification for the loadbar, determined in part by the configuration of the loadcells utilised.

In examples, each loadbar is elongate, with the processing module provided at one end of the loadbar. In examples, the first loadbar and the second loadbar may be installed in a substantially parallel orientation, such that the respective processing modules are disposed towards same edge of the weighing platform.

According to one aspect of the present technology there is provided a loadbar configured to support a weighing platform in use, the loadbar including:
a base portion having a first end and a second end;
at least two load cells provided to the base portion, each load cell configured to output an indicator of force applied to the load cell;
a processing module including a wireless communication device,
wherein the processing module includes a processing module enclosure configured to be releasably secured relative to the base portion at the first end.

In examples, the base portion comprises a recess configured to receive the processing module enclosure. In examples, the base portion and the processing module enclosure may be configured such that the processing module enclosure may slide relative to the recess along the longitudinal axis of the base portion. In examples the base portion includes at least one first retention feature, and the processing module enclosure includes at least one second retention feature, wherein the first retention feature and the second retention feature are configured to be engaged to retain the processing module enclosure relative to the base portion.

In examples, the loadbar includes a platform support member configured to extend over the load cells and a superior surface of the processing module enclosure, wherein the platform support member is open at the first end such that a portion of the processing module enclosure is exposed (i.e. a surface of the enclosure facing away from the load cells in a direction along the longitudinal axis of the base portion between the first end and the second end).

In examples, the processing module enclosure does not extend beyond the first end of the base portion and/or the platform support member such that the processing module enclosure is at least partially shielded by those components.

The above and other features will become apparent from the following description and the attached drawings.

### BRIEF DESCRIPTION OF THE DRAWINGS

Further aspects of the present disclosure will become apparent from the following description which is given by way of example only and with reference to the accompanying drawings in which:

FIG. 1 is a schematic diagram of an exemplary weighing system according to one aspect of the present technology;

FIG. 2A to 2I are views of components of an exemplary wireless loadbar weighing system according to one aspect of the present technology; and

FIG. 3A and FIG. 3B are timing diagrams of force data streams according to one aspect of the present technology.

### DETAILED DESCRIPTION

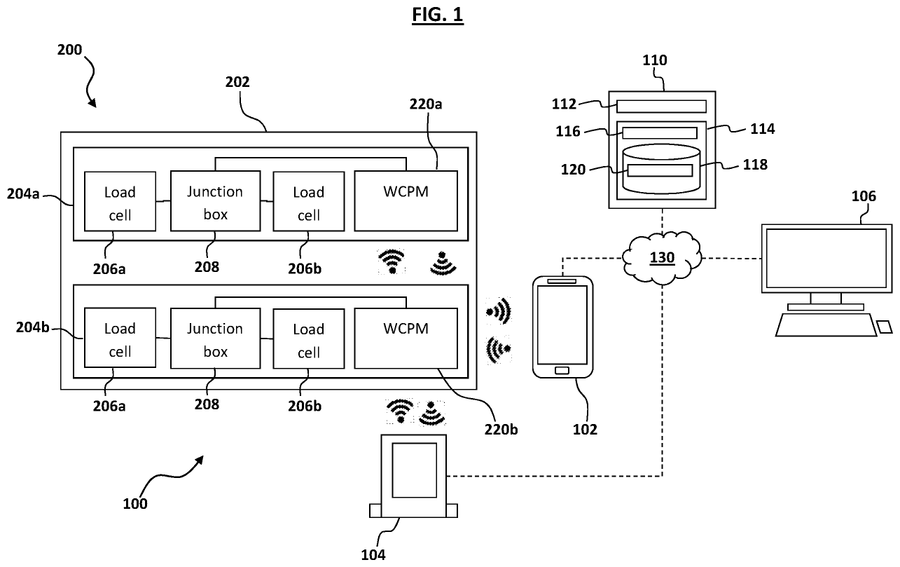

FIG. 1 illustrates an exemplary weighing system 100 according to one aspect of the present technology. The weighing system 100 includes a wireless loadbar weighing system 200, in this example including a weighing platform 202 supported by a pair of loadbars (first loadbar 204a and second loadbar 204b).

In the example illustrated, each loadbar 204 includes a first load cell 206a and a second load cell 206b. In one exemplary configuration, each load cell 206 may include two strain gauges forming the arms of a wheatstone bridge, the output of which is indicative of force applied to the load cell 206 by an object supported on the weighing platform 202. In this example, a wired connection is provided between the load cells and a junction box 208, where the power and signal lines are essentially connected in parallel.

Each loadbar 204 includes a processing module including a wireless communication device—referred to herein as a wireless communication and processing module (“WCPM”) 220—in wired communication with the junction box 208. The WCPM 220 includes a self-contained power source, for example a battery. The WCPM 220 supplies power to the load cells 206, and receives the signals output indicative of force applied. In the exemplary embodiment, the WCPM 220 are configured to communicate directly with each other over a local wireless connection—for example using Bluetooth™ Low Energy protocol.

The respective WCPM 220 of the first loadbar 204a and the second loadbar 204b are configured in a primary and secondary relationship (also known in the art as a master/slave model), as will be described further below. The WCPM 220 of the first loadbar 204a will be referred to herein as secondary WCPM 220a, and the WCPM 220 of the second loadbar 204b will be referred to as primary WCPM 220b. For completeness, it should be appreciated that the respective WCPM 220 may be configured, or re-configured, in the inverse primary/secondary relationship.

In this example, the primary WCPM 220b is configured to communicate with a remote device such as a user device (for example, smart phone 102), and/or a dedicated weighscale device 104, directly over a local wireless connection—for example using Bluetooth™ Low Energy protocol. For completeness, it should be noted that the secondary WCPM 220a is capable of communicating with the external devices, but does not do so for the purpose of transmitting weight data while configured as the secondary device—as described further below.

In exemplary embodiments, the smart phone 104 or weighscale device 104 may communicate with a data management service 110 via a network 130 (for example a cellular network, or another network potentially comprising various configurations and protocols including the Internet, intranets, virtual private networks, wide area networks, local networks, private networks using communication protocols proprietary to one or more companies—whether wired or wireless, or a combination thereof). For example, the smart phone 104 may operate an application capable of interfacing with the data management service 110.

Among other functions, the data management service 110 may record data obtained from the wireless loadbar weighing system 200, perform analysis on the received data, and report to one or more user devices. In this exemplary embodiment, the data management service 110 is illustrated as being implemented in a server—for example one or more dedicated server devices, or a cloud based server architecture. By way of example, cloud servers implementing the data management service 110 may have processing facilities represented by processors 112, memory 114, and other components typically present in such computing environments. In the exemplary embodiment illustrated the memory 114 stores information accessible by processors 112, the information including instructions 116 that may be executed by the processors 112 and data 118 that may be retrieved, manipulated or stored by the processors 112. The memory 114 may be of any suitable means known in the art, capable of storing information in a manner accessible by the processors, including a computer-readable medium, or other medium that stores data that may be read with the aid of an electronic device. The processors 112 may be any suitable device known to a person skilled in the art. Although the processors 112 and memory 114 are illustrated as being within a single unit, it should be appreciated that this is not intended to be limiting, and that the functionality of each as herein described may be performed by multiple processors and memories, that may or may not be remote from each other.

The instructions 116 may include any set of instructions suitable for execution by the processors 112. For example, the instructions 116 may be stored as computer code on the computer-readable medium. The instructions may be stored in any suitable computer language or format. Data 118 may be retrieved, stored or modified by processors 112 in accordance with the instructions 116. The data 118 may also be formatted in any suitable computer readable format. Again, while the data is illustrated as being contained at a single location, it should be appreciated that this is not intended to be limiting—the data may be stored in multiple memories or locations.

It should be appreciated that in exemplary embodiments the functionality of the data management service 110 may be realized in a local application, or a combination of local and remote applications.

Weight data may also be accessed via a user workstation 106—whether via the data management service 110, or via direct communication with the smart phone 102 or weighscale device 104.

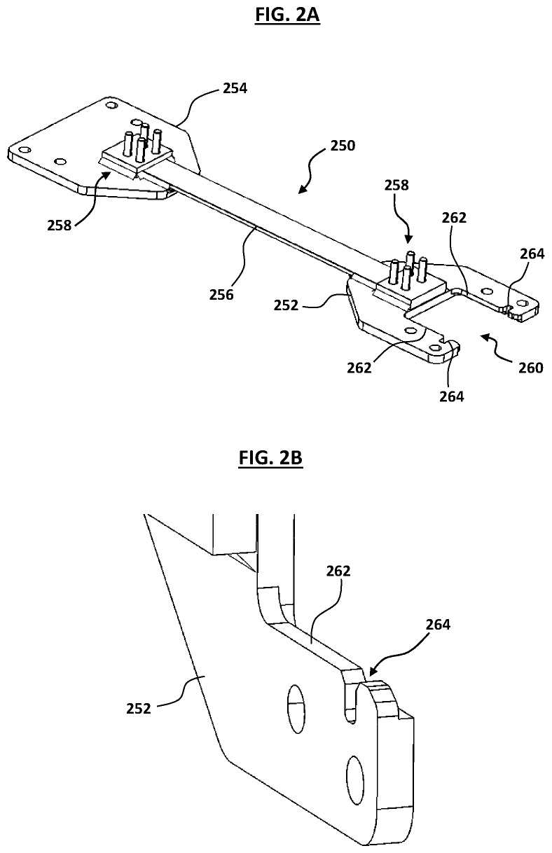

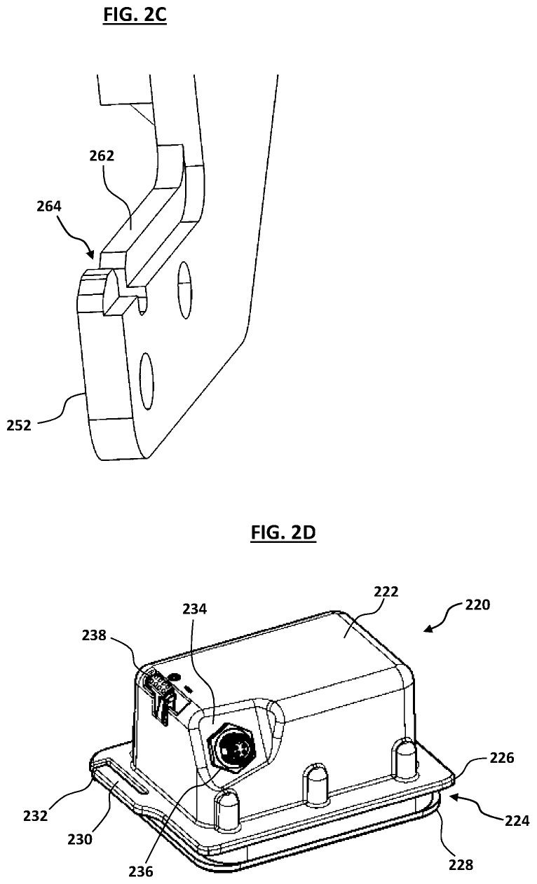

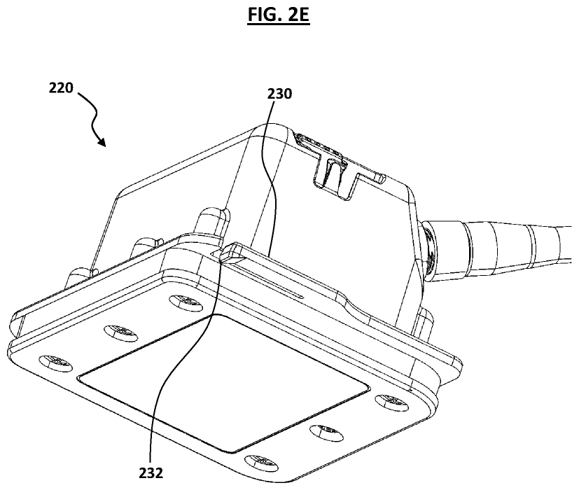

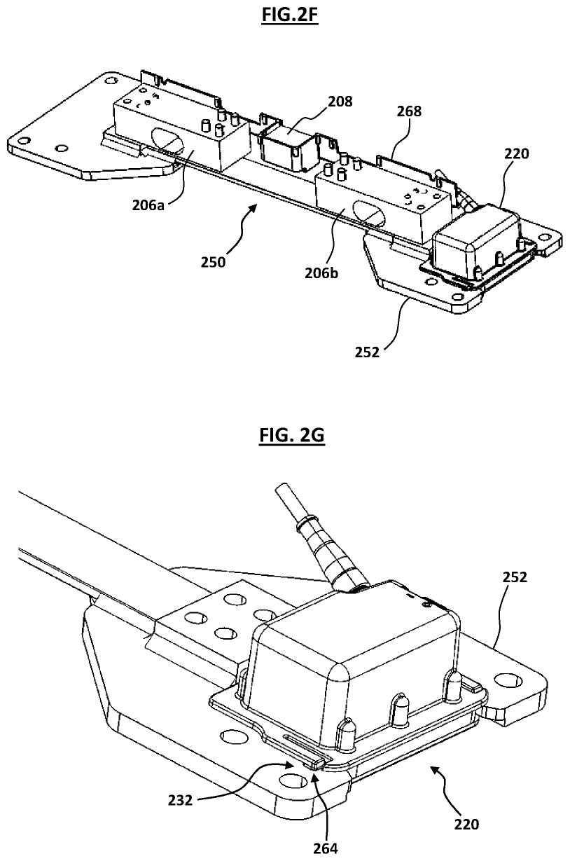

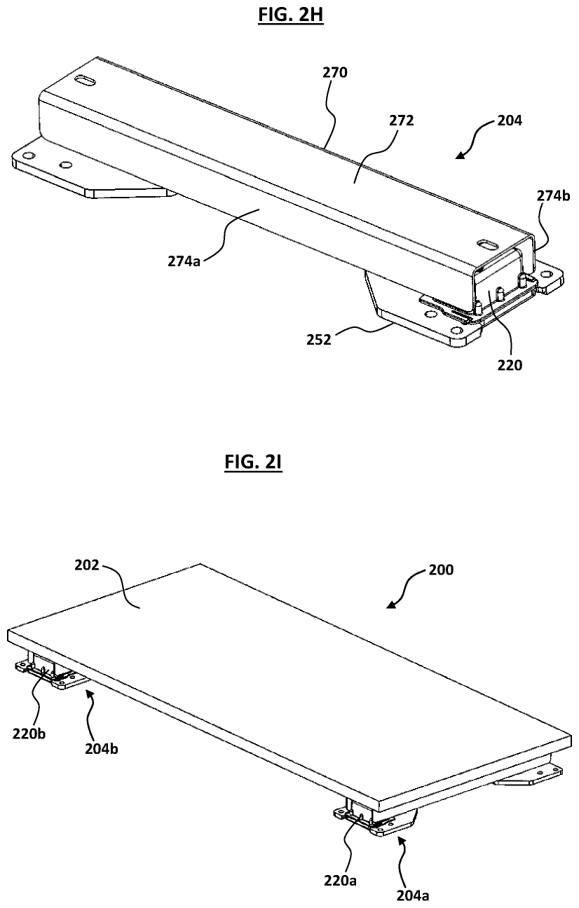

FIG. 2A to 2I show an exemplary wireless loadbar weighing system 200 and components thereof. FIG. 2A shows a base portion 250 of a loadbar 204 according to one aspect of the present disclosure, the base portion 250 including a first end base plate 252 and a second end base plate 254, with an elongate bridging member 256 therebetween. Load cell mounts 258 are provided at each of the first end base plate 252 and the second end base plate 254.

The first end base plate 252 has a locating recess 260 at an edge distal from the second end base plate 254. The locating recess 260 includes a locating flange 262 on each side, each locating flange further including a locating notch 264 (also shown in FIG. 2B and FIG. 2C).

Referring to FIG. 2D and FIG. 2E, an exemplary WCPM 220 is illustrated, having an enclosure 222 containing the electronic components of the WCPM 222. The base of the enclosure 222 includes a locating groove 224 provided between a superior flange 226 and an inferior flange 228. A resilient locating arm 230 is provided in the superior flange 226 on both sides of the enclosure 222, the resilient locating arm 230 including an inferior locating projection 232.

The enclosure 222 further includes a cable connector surface 234, the cable connector surface 234 angled to face in a superior-posterior direction (where the posterior of the loadbar 204 is at the opposing end of the loadbar 204 to the enclosure 222). A cable connector 236 is provided to the cable connector surface 234, enabling connection to a cable between the junction box 208 and the WCPM 220. An operable switch 238 is provided on the enclosure 222, enabling a user to turn power on and off. In examples, the switch 238 may be physically isolated from the interior of the enclosure 222, to protect the interior from exposure to the environment. For example, the switch 238 may be a magnetic switch (e.g. a magnet in combination with a reed switch or hall effect sensor).

As shown in FIG. 2F and FIG. 2G, the enclosure 222 may be slid into the locating recess 260 of the first end base plate 252, the locating flange 262 received in the locating groove 224. When in position, the inferior locating projections 232 are biased into the locating notches 264 by the resilience of the locating arm 230 to hold the enclosure 222 in place. Removal of the enclosure 222 involves sliding the enclosure 222 in a direction away from the second end base plate 254, having lifted the inferior locating projections 232 from the locating notches 264.

Referring to FIG. 2F, the loadbar 204 may include a vermin excluder 268 extending along the loadbar 204 between the load cells 206, restricting access to the associated cabling by pests.

Referring to FIG. 2H, the loadbar 204 includes a platform support member 270 having a superior portion 272 configured to extend over the load cells and a superior surface of the WCPM 220, and side portions 274 extending in an inferior direction from the superior portion 272. It may be seen that the platform support member 270 is open at a first end proximal to the first end base plate 252 such that a portion of the WCPM 220 is exposed (i.e. a surface of the enclosure 222 facing away from the load cells 206 in a direction along the longitudinal axis of the base portion 240). This arrangement protects the WCPM 220 while still enabling access for (a) removal and installation, and (b) transmission of wireless signals.

FIG. 2I shows an assembled a wireless loadbar weighing system 200, in this example including a weighing platform 202 supported by a pair of loadbars (first loadbar 204a and second loadbar 204b). It may be seen that the loadbars 204a and 204b are arranged in parallel, and oriented so that the respective WCPMs 220 are proximal to a common edge of the weighing platform 202. In doing so, it is envisaged that this may assist in achieving a relatively clear transmission path between the WCPMs 220, particularly in comparison with arrangements in which the WCPMs 220 may be required to transmit between opposing edges of the weighing platform 202.

As noted above, the WCPMs 220 are configured in a primary/secondary relationship. Generally speaking, the secondary WCPM 220a is configured to transmit force measurements from its load cells 206 to primary WCPM 220b, and the primary WCPM 220b is configured to determine values indicative of weight based on the force measurements collected from its own load cells 206, and the received force measurements from the secondary WCPM 220a. The primary WCPM 220b is further configured to transmit the weight data to the remote device (e.g. smart phone 102 or weighscale 104).

The WCPMs 220 of a wireless loadbar weighing system 200 are configured to develop an affinity, such that they function as an exclusive pair (i.e. not connecting to any other WCPMs 220 within transmission range). In examples in which a WCPM 220 is replaced, the existing (i.e remaining) WPCM 220 may register affinity with the replacement WPCM 220 and transfer configuration parameters to the replacement WPCM which establishes it as a one of the pair of WPCMs 220 for that particular wireless loadbar weighing system 200. In examples this may include registering a unique identifier for the wireless loadbar weighing system 200 with the replacement WPCM 220.

Determination of which WCPM 220 is configured as the primary WCPM may be based on one or more factors such as current battery capacity, or signal strength with the remote device. In examples, primary WCPM may be reassigned on determination of changes in these factors. For example, during start-up each WPCM 220 may communicate with a remote device (e.g. smartphone 102 or weighscale 104) and the WPCM 220 with the strongest signal strength may be designated as the primary WPCM. Selection of the WPCM 220 with the strongest signal strength is believed to increase performance in terms of range and reliability for transmission of the weight data.

As a further example, a WCPM 220 initially designated as the primary WCPM may use more power as the result of processing and transmission of the weight data. On determination that the primary WCPM battery capacity has decreased below that of the secondary WCPM, the primary/secondary configurations may be switched. It is envisaged that this may assist with enabling the wireless loadbar weighing system 200 to function for the longest period before servicing is required to replace a discharged battery.

In use, signals output from the load cells 206 are processed by their respective WCPM 220 to obtain a sequence of force measurements. In examples, the force measurements are obtained using an analog to digital (“A to D”) converter converting the analogue measurement signal to a digital representation of the magnitude of that signal. Each A to D converter has an associated clock, enabling each force measurement to be assigned an associated timestamp to assist with alignment of data between WCPMs 220.

In examples, the secondary WCPM 220a is configured to transmit force data packets to the primary WCPM 220b, each force data packet including more than one force measurement. In an example, the force measurements are obtained at intervals of about 12.5 ms, and force data packets containing two force measurements are transmitted at 50 ms intervals. It is envisaged that this may assist with conserving energy associated with transmission, while still enabling an acceptable refresh rate for the subsequent processing and transmission of weight data.

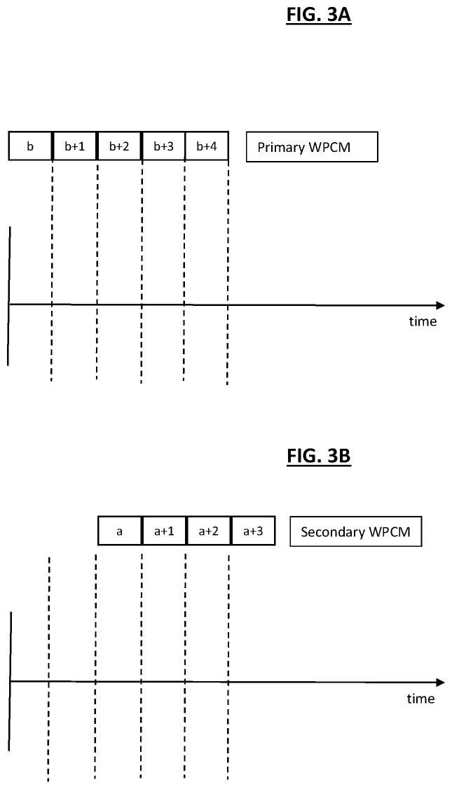

In examples, force measurements are recorded in respective measured force data streams. The primary WCPM 220b may be configured to only record force measurements in a force data stream once there is a correlation between force measurements in terms of corresponding time stamps. For example, referring to FIG. 3A and FIG. 3B, the primary WCPM 220b may collect force measurements b, b+1, b+2, b+3, b+4. However, force measurements b and b+1 may be discarded, as the timestamps of force measurements a to a+n received from the secondary WCPM 220a do not correspond to those of b and b+1.

In practice, clock drift will occur between the WCPMs 220, as one of the A to D convertor will always run faster than the other due to differences in the clock crystal frequency. Eventually this clock drift will result in inaccuracies as force measurements become misaligned, and calculated weight measurements become less accurate. As such, the primary WCPM is configured to discard individual force measurements from the respective force data streams in order to synchronise the force data streams.

For example, referring to FIG. 3A and FIG. 3B, the data points b+3 and b+4 may be compared with a+1 and a+2 as follows. The time distances between data points are calculated as follows (where RTC_SourceB is the realtime clock value of the primary WCPM 220b, and RTC_SourceA is the realtime clock value of the secondary WCPM 220a):

$$TimeDistance 1 = ( b + 3 ) RTC\_SourceB - ( a + 1 ) RTC\_SourceA$$

$$TimeDistance 2 = ( b + 3 ) RTC\_SourceB - ( a + 2 ) RTC\_SourceA$$

$$TimeDistance 3 = ( b + 4 ) RTC\_SourceB - ( a + 1 ) RTC\_SourceA$$

The following decisions are taken based upon the time distance determination:
Synchronised: When TimeDistance1 is less than both TimeDistance2 and TimeDistance3;
Drop (b+1): When TimeDistance2 is less than both TimeDistance1 and TimeDistance3; and
Drop (a+3): When TimeDistance3 is less than both TimeDistance1 and TimeDistance2.

In examples, the respective clocks of the WCPMs 220 may be resynchronized periodically—for example every 60 seconds.

The primary WCPM 220b then calculates a value for the weight of an object (e.g. an animal) on the wireless loadbar weighing system 200 from the synchronized force measurement data. It should be appreciated that the value for the weight may include live weight values and lock weight values—where the live weight values are dynamic (i.e. changing as the weight of the object is redistributed, such as where the animal shifts position), and the lock weight is a static value determined to be relatively stable.

In examples, the weight values are transmitted from the primary WCPM 220b to the remote device 102/104 in packets containing multiple values (for example, four values per packet) at intervals of less than one second—for example in the order of 200 milliseconds.

In alternative embodiments, the respective WCPMs 220 may transmit the force data to the remote device 102/104, and the remote device 102/104 may perform the synchronization of the force data streams and calculation of the weight values described above.

The weight values may be utilised in a variety of ways known in the field of animal husbandry. By way of example, the weight values may be associated with a unique animal identifier for the animal being weighed.

In examples, the WCPMs 220 may be configured to automatically power down, or at least reduce functions performed, on determining that the wireless loadbar weighing system 200 is not currently in use (for example in the absence of a live weight reading within a predetermined period of time).

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor. A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers, whether cloud based or dedicated, and network connections as known in the art.

In various embodiments, one or more cloud computing environments may be used to create, and/or deploy, and/or operate at least part of the software system that can be any form of cloud computing environment, for example: a public cloud, a private cloud, a virtual private network (VPN), a subnet, a Virtual Private Cloud (VPC), or any other cloud-based infrastructure known in the art. It should be appreciated that a service may utilize, and interface with, multiple cloud computing environments.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The illustrated embodiments of the disclosure will be best understood by reference to the figures. The foregoing description is intended only by way of example and simply illustrates certain selected exemplary embodiments of the disclosure. It should be noted that the flowchart and block diagrams in the figures illustrate the architecture, functionality, and operation of possible implementations of systems, apparatuses, methods and computer program products according to various embodiments of the disclosure. In this regard, each block in the flowchart or block diagrams may represent a module, segment, or portion of code, which includes at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The entire disclosures of all applications, patents and publications cited above and below, if any, are herein incorporated by reference. Reference to any prior art in this specification is not, and should not be taken as, an acknowledgement or any form of suggestion that that prior art forms part of the common general knowledge in the field of endeavour in any country in the world.

The invention(s) of the present disclosure may also be said broadly to consist in the parts, elements and features referred to or indicated in the specification of the application, individually or collectively, in any or all combinations of two or more of said parts, elements or features. Where in the foregoing description reference has been made to integers or components having known equivalents thereof, those integers are herein incorporated as if individually set forth.

Furthermore, the described features, structures, or characteristics may be combined in any suitable manner in at least one embodiment. In the foregoing description, numerous specific details are provided to give a thorough understanding of the exemplary embodiments. One skilled in the relevant art may well recognize, however, that embodiments of the disclosure can be practiced without at least one of the specific details thereof, or can be practiced with other methods, components, materials, et cetera. In other instances, well-known structures, materials, or operations are not shown or described in detail to avoid obscuring aspects of the invention.

Throughout this specification, the word “comprise” or “include”, or variations thereof such as “comprises”, “includes”, “comprising” or “including” will be understood to imply the inclusion of a stated element, integer or step, or group of elements integers or steps, but not the exclusion of any other element, integer or step, or group of elements, integers or steps, that is to say, in the sense of “including, but not limited to”.

Aspects of the present disclosure have been described by way of example only and it should be appreciated that modifications and additions may be made thereto without departing from the scope thereof.

1. A wireless loadbar weighing system including:
a first loadbar;
a second loadbar;
wherein the first loadbar and the second loadbar are configured to support a weighing platform in use,
wherein each of the first loadbar and the second loadbar are configured to measure force applied by the weighing platform, and produce first measured force data and second measured force data respectively,
wherein each of the first loadbar and the second loadbar include a processing module including a wireless communication device,
wherein at least one of the first loadbar and the second loadbar is configured to wirelessly transmit, to a remote device for further processing and/or display, at least one of: the first measured force data and the second measured force data, and a weight measurement of a mass supported by the weighing platform determined based on the first measured force data and the second measured force data.

2. The wireless loadbar weighing system of claim 1, wherein the first loadbar is configured to wirelessly transmit the first measured force data to the second loadbar, and
wherein the second loadbar is further configured to wirelessly transmit the first measured force data and the second measured force data to the remote device,
wherein the remote device is configured to determine a weight measurement of a mass supported by the weighing platform based on the first measured force data and the second measured force data.

3. The wireless loadbar weighing system of claim 1, wherein the first loadbar is configured to wirelessly transmit the first measured force data to the remote device, and the second loadbar to wirelessly transmit the second measured force data to the remote device,
wherein the remote device is configured to determine a weight measurement of a mass supported by the weighing platform based on the first measured force data and the second measured force data.

4. The wireless loadbar weighing system of claim 1, wherein the first loadbar is configured to wirelessly transmit the first measured force data to the second loadbar, and the second loadbar is configured to determine a weight measurement of a mass supported by the weighing platform based on the first measured force data and the second measured force data, and
wherein the second loadbar is further configured to wirelessly transmit the weight measurement to a remote device for further processing and/or display.

5-12. (canceled)

13. The wireless loadbar weighing system of claim 4, wherein the weight measurement is transmitted from the second loadbar to the remote device at intervals of less than one second.

14-16. (canceled)

17. The wireless loadbar weighing system of claim 4, wherein the first measured force data is transmitted from the first loadbar to the second loadbar at intervals of not more than 100 milliseconds.

18. (canceled)

19. The wireless loadbar weighing system of claim 4, wherein the transmission of the first measured force data and the transmission of the weight measurement are non-coincident.

20. (canceled)

21. The wireless loadbar weighing system of claim 4, wherein respective force measurements of the first measured force data and the second measured force data are aligned before determining the weight measurement.

22. The wireless loadbar weighing system of claim 21, wherein the received first measured force data is included in a first measured force data stream, and the second measured force data is included in a second measured force data stream.

23. The wireless loadbar weighing system of claim 22, wherein the force measurements are not included in, or discarded from, the first measured force data stream or the second measured force data stream until force measurements have been received from both processing modules within a predetermined time interval.

24. The wireless loadbar weighing system of claim 21, wherein alignment of the respective force measurements of the first measured force data stream and the second measured force data stream includes discarding of a force measurement from the first measured force data stream or the second measured force data stream.

25. The wireless loadbar weighing system of claim 24, wherein discarding of a force measurement is based on a determined time distance between force measurements of the first measured force data and the second measured force data respectively.

26. The wireless loadbar weighing system of claim 25, wherein each of the processing modules includes an analog to digital converter having an associated clock, wherein the clock rate between the respective processing modules is less than 1.5 hertz.

27-28. (canceled)

29. The wireless loadbar weighing system of claim 4, wherein one of the respective processing modules of the first loadbar and the second loadbar is selectively configured as a primary processing module responsible for determining the weight measurement and transmission of same to the remote device.

30. The wireless loadbar weighing system of claim 29, wherein the configuration of a processing module as the primary processing module is based on a relative battery state of charge between the loadbars.

31. The wireless loadbar weighing system of claim 29, wherein the configuration of a processing module as the primary processing module is based on a relative signal strength of a wireless connection between the processing modules and the remote device.

32. The wireless loadbar weighing system of claim 4, wherein the respective processing modules of the first loadbar and the second loadbar respective processing modules are configured to have an affinity established therebetween, wherein the processing modules are configured to only transmit measured force data to another processing module with which it has affinity.

33. The wireless loadbar weighing system of claim 1, wherein each loadbar is elongate, with the processing module provided at one end of the loadbar.

34. (canceled)

35. The wireless loadbar weighing system of claim 33, wherein each loadbar includes:
a base portion having a first end and a second end;
at least two load cells provided to the base portion, each load cell configured to output an indicator of force applied to the load cell;
wherein the processing module includes a processing module enclosure configured to be releasably secured relative to the base portion at the first end.

36-38. (canceled)

39. The wireless loadbar weighing system of claim 35, wherein each loadbar includes a platform support member configured to extend over the load cells and a superior surface of the processing module enclosure, wherein the platform support member is open at the first end such that a portion of the processing module enclosure is exposed.

40. (canceled)
